(19) United States
(12) Patent Application Publication
(10) Pub. No.: US 2026/0252657 A1
(43) Pub. Date: Aug. 27, 2026

(54) PAGE LOADING METHOD, DEVICE AND STORAGE MEDIUM

(71) Applicant: Beijing Youzhuju Network Technology Co., Ltd., Beijing (CN)

(72) Inventors: Boqi ZHANG, Beijing (CN); Li LI, Beijing (CN); Jiangtao GU, Beijing (CN); Ning CHEN, Beijing (CN); Yijun ZHANG, Beijing (CN); Shaozong SUN, Beijing (CN)

(21) Appl. No.: 19/531,608

(22) Filed: Feb. 5, 2026

(30) Foreign Application Priority Data
Feb. 26, 2025 (CN) 202510221277.5

(51) Int. Cl. G06F 16/957; G06F 16/958

(52) U.S. Cl. CPC G06F 16/9574; G06F 16/958

(57) ABSTRACT

The present disclosure provides a page loading method, a device, and a storage medium. The method includes: preloading a preloaded resource of a first landing page into a memory cache of a first browser in response to a launch of a first application, where the first landing page is a third-party landing page; and in response to a load trigger operation on the first landing page, reading the preloaded resource of the first landing page from the memory cache through the first browser, and loading the first landing page based on the preloaded resource of the first landing page.

### CROSS-REFERENCE TO RELATED APPLICATION

This application claims the priority to and benefits of the Chinese Patent Application, No. 202510221277.5, which was filed on February 26, 2025. The aforementioned patent application is hereby incorporated by reference in its entirety.

### TECHNICAL FIELD

One or more embodiments of the present disclosure relates to the field of computer technologies, and in particular, to a page loading method, a device, and a storage medium.

### BACKGROUND

A landing page is an information presentation method in the form of a web page, for example, an advertisement landing page, which has the capabilities of rich content displaying, information reporting, real-time charging, and traffic diversion. For a third-party landing page of an application, due to uneven implementation quality, the page loading time may be long, resulting in a poor user loading experience, which needs to be improved.

### SUMMARY

To solve the above technical problems, one or more embodiments of the present disclosure provide a page loading method and apparatus, a device, and a medium.

At least an embodiment of the present disclosure provides a page loading method. The method includes:

preloading a preloaded resource of a target landing page (e.g., first land page) into a memory cache of a target browser (e.g., first browser) in response to a launch of a target application (e.g., first application), where the target landing page is a third-party landing page; and

in response to a load trigger operation on the target landing page, reading the preloaded resource of the target landing page from the memory cache through the target browser, and loading the target landing page based on the preloaded resource of the target landing page.

At least an embodiment of the present disclosure further provides a page loading apparatus. The apparatus includes:

a preloading module configured to preload a preloaded resource of a target landing page into a memory cache of a target browser in response to a launch of a target application, where the target landing page is a third-party landing page; and

a loading module configured to read the preloaded resource of the target landing page from the memory cache through the target browser in response to a load trigger operation on the target landing page, and load the target landing page based on the preloaded resource of the target landing page.

At least an embodiment of the present disclosure further provides an electronic device. The electronic device includes at least one processor and at least one memory configured to store computer instructions executable by the at least one processor, where the computer instructions, when executed by the at least one processor, causes the at least one processor to perform the page loading method provided by one or more embodiments of the present disclosure.

At least an embodiment of the present disclosure further provides a non-transitory computer-readable storage medium is stored with computer instructions, and the computer instructions, when executed by at least a processor, cause the processor to perform the page loading method provided by one or more embodiments of the present disclosure.

### BRIEF DESCRIPTION OF DRAWINGS

The above and other features, advantages, and aspects of one or more embodiments of the present disclosure become more apparent with reference to the following specific implementations and in conjunction with the drawings. Throughout the drawings, the same or similar reference numerals denote the same or similar elements. It should be understood that the drawings are schematic and that parts and elements are not necessarily drawn to scale.

FIG. 1 is a schematic flowchart of a page loading method according to at least an embodiment of the present disclosure;

FIG. 2 is a schematic flowchart of another page loading method according to at least an embodiment of the present disclosure;

FIG. 3 is a schematic diagram of a page loading process according to at least an embodiment of the present disclosure;

FIG. 4 is a schematic diagram of another page loading process according to at least an embodiment of the present disclosure;

FIG. 5 is a schematic diagram of a structure of a page loading apparatus according to at least an embodiment of the present disclosure; and

FIG. 6 is a schematic diagram of a structure of an electronic device according to at least an embodiment of the present disclosure.

### DETAILED DESCRIPTION

One or more embodiments of the present disclosure are described in more detail below with reference to the drawings. Although some embodiments of the present disclosure are shown in the drawings, it should be understood that the present disclosure may be implemented in various forms and should not be construed as limited to the embodiments set forth herein. Instead, these embodiments are provided for a more thorough and complete understanding of the present disclosure. It should be understood that the drawings and embodiments of the present disclosure are only for exemplary purposes and are not intended to limit the protection scope of the present disclosure.

It should be understood that the various steps described in the method implementations of the present disclosure may be performed in different orders and/or in parallel. In addition, the method implementations may include additional steps and/or omit the steps shown. The scope of the present disclosure is not limited in this regard.

The term "include/comprise" and its variations used herein are open-ended inclusions, that is, "include/comprise but not limited to". The term "based on" is "at least partially based on". The term "an embodiment" means "at least one embodiment". The term "another embodiment" means "at least one other embodiment". The term "some embodiments" means "at least some embodiments". Related definitions of other terms are given in the following description.

It should be noted that the concepts such as "first" and "second" mentioned in the present disclosure are only used to distinguish different apparatuses, modules or units, and are not used to limit the order or interdependence of the functions performed by these apparatuses, modules or units.

It should be noted that the modifications of "one" and "multiple" mentioned in the present disclosure are illustrative rather than restrictive. Those skilled in the art should understand that unless otherwise clearly indicated in the context, they should be understood as "one or more".

The names of messages or information exchanged between multiple apparatuses in the implementations of the present disclosure are only for illustrative purposes, and are not intended to limit the scope of these messages or information.

To solve the problem of an excessively long loading time of a third-party landing page in the related art, at least an embodiment of the present disclosure provides a page loading method, which is described below with reference to specific embodiments.

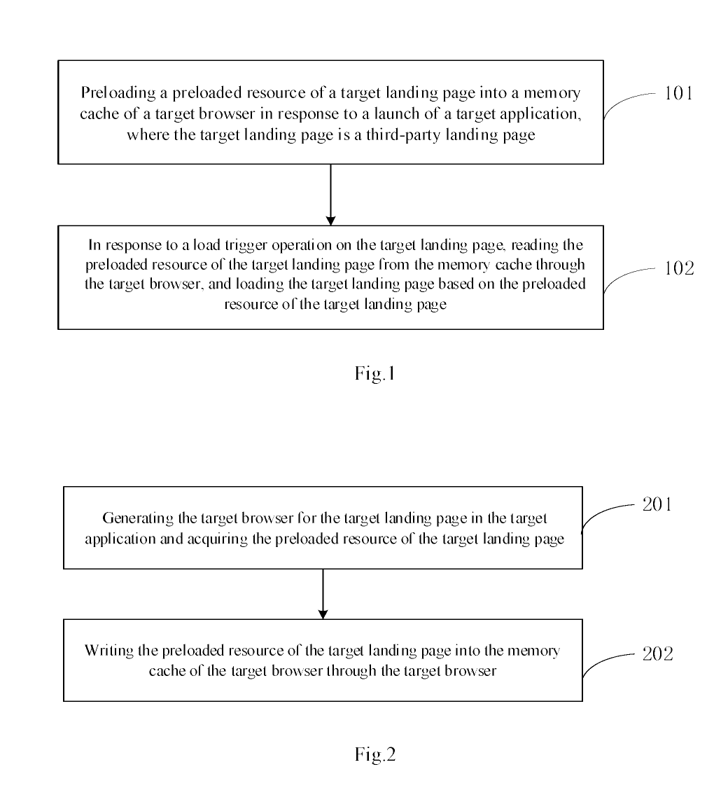

FIG. 1 is a schematic flowchart of a page loading method according to at least an embodiment of the present disclosure. The method may be performed by a page loading apparatus, which may be implemented in software and/or hardware and may generally be integrated into an electronic device. As shown in FIG. 1, the method includes:

Step 101: preloading a preloaded resource of a target landing page into a memory cache of a target browser in response to a launch of a target application, where the target landing page is a third-party landing page.

The target application may be any application that requires time optimization for loading its third-party landing page, and the specific type and number thereof are not limited. For example, the target application may be a short video application, a live streaming application, a reading application, etc. A landing page is an information presentation method in the form of a web page, and its purpose is to guide a visitor to complete a specific action, such as browsing information, filling out a form, downloading an application, registering for a service, etc. When a user clicks on a preset landing page entry, the user may directly jump to this page. The preset landing page entry may be an advertisement, a search result, a link, etc. The landing page is highly targeted and guiding. The target landing page in one or more embodiments of the present disclosure may be a third-party landing page, and the third-party landing page refers to a landing page that is produced and implemented by a third party and does not belong to the target application. Resources of the third-party landing page need to be acquired from an external server.

The preloaded resource may be a resource that may be downloaded and cached in advance among all resources of a landing page. The preloaded resource may include a static resource, a resource with a long cache timeliness, and a resource without anti-caching settings. The preloaded resource in one or more embodiments of the present disclosure may include at least one of the following: an image, a font format template file, a script file, etc. The script file may include a cross-domain script file, and the cross-domain script file is only downloaded but not executed by modifying a reference manner, so as to avoid some logic of the landing page, such as statistics, network requests, etc., from being sent in advance.

Specifically, a user may trigger the launch of the target application, and the page loading apparatus may generate a browser for the target landing page in advance in response to the launch of the target application, and write the preloaded resource of the target landing page into the memory cache of the target browser. Here, preloading refers to loading in advance before the launch of the target landing page, and the loading speed of the subsequent landing page may be improved by reusing the memory cache of the browser.

Exemplarily, FIG. 2 is a schematic flowchart of another page loading method according to at least an embodiment of the present disclosure. As shown in FIG. 2, preloading the preloaded resource of the target landing page into the memory cache of the target browser may include the following steps.

Step 201: generating the target browser for the target landing page in the target application and acquiring the preloaded resource of the target landing page.

The target browser may be an embedded browser of the target application or a browser instance, and a corresponding embedded browser is generated for each landing page to load the landing page.

Specifically, after the target application is launched, the page loading apparatus may first generate the target browser corresponding to the target landing page in the target application. If the target browser has already been generated, the page loading apparatus may acquire the target browser. The page loading apparatus may acquire the preloaded resource of the target landing page in advance according to a page address of the target landing page, which may be specifically acquired in a local storage space or a server of the target landing page.

In some embodiments, the acquiring the preloaded resource of the target landing page may include: determining whether the preloaded resource of the target landing page exists in the local storage space; if yes, acquiring the preloaded resource of the target landing page from the local storage space; otherwise, acquiring the preloaded resource of the target landing page from a target server (e.g., first server) corresponding to the target landing page.

The local storage space may be a disk of an electronic device where the target application is located. When acquiring the preloaded resource of the target landing page, the page loading apparatus may first read the preloaded resource in the local storage space. If the preloaded resource of the target landing page exists in the local storage space, the page loading apparatus acquires the preloaded resource from the local storage space. If the preloaded resource of the target landing page does not exist in the local storage space, the page loading apparatus may send a network request to acquire the corresponding preloaded resource from the target server corresponding to the target landing page. The target server may be a resource storage server of the target landing page. By downloading the resource to the local first and then acquiring it through the network when the local does not have the resource, this method may further improve the resource loading speed.

Optionally, acquiring the preloaded resource of the target landing page from the target server corresponding to the target landing page includes: sending a resource obtaining request to the target server corresponding to the target landing page based on a resource address of the preloaded resource to acquire the preloaded resource, where the resource address of the preloaded resource is obtained through domain name resolution in advance in response to display of an information page with a page entry of the target landing page.

The resource address of the preloaded resource may be a unique identifier used to identify and locate a network resource. The page entry of the target landing page may be an entry control that may quickly enter the target landing page, and the information page may include one or more such entry controls so that the target landing page may be jumped to when the user performs a trigger operation. Domain name resolution, also known as DNS (Domain Name System) resolution, may be a process of mapping to a corresponding IP (Internet Protocol Address) address through the DNS protocol when accessing a certain domain name. Specifically, when acquiring the preloaded resource of the target landing page from the target server corresponding to the target landing page, the page loading apparatus may acquire the pre-resolved resource address of the preloaded resource, and send the resource obtaining request to the target server of the target landing page based on the resource address to acquire the preloaded resource. In addition, the page loading apparatus may perform domain name resolution on a domain name of the preloaded resource of the target landing page in the information page to obtain the resource address in response to the display of the information page with the page entry of the target landing page, and store the resource address into the local storage space so that the preloaded resource may be directly acquired through the resource address in subsequent acquisition.

In the related art, when loading resources of a landing page, a significant delay is added due to domain name resolution, which may greatly reduce the loading performance for websites with many third-party landing pages.

In the above solution, through domain name resolution on the preloaded resource of the third-party landing page in advance, the resource may be quickly acquired when the resource is acquired, thereby greatly reducing the domain name resolution time, further shortening the page loading time, and improving the page loading speed.

Step 202: writing the preloaded resource of the target landing page into the memory cache of the target browser through the target browser.

Specifically, after acquiring the preloaded resource of the target landing page, the page loading apparatus may write the preloaded resource of the target landing page into the memory cache of the target browser through the target browser, and the loading speed of the subsequent landing page may be improved by reusing the memory cache of the browser.

In some embodiments, the writing the preloaded resource of the target landing page into the memory cache of the target browser through the target browser includes: acquiring a web page directory file of the target landing page through the target browser; and triggering, based on a preload tag in the web page directory file, writing multiple preloaded resources corresponding to the preload tag into the memory cache of the target browser.

The web page directory file may be a file that includes a directory of one or more preloaded resources and is preset with a preload tag for each preloaded resource. The web page directory file may be a Hyper Text Markup Language 5 (HTML5) file, and the preload tag is used to provide a way for the browser to write the resource into the memory cache of the browser. For an electronic device running an operating system whose browser engine is not provided to write into the browser memory cache, the resource may be written into the browser memory cache in this way. Specifically, the page loading apparatus may acquire the corresponding web page directory file from the local storage space or the target server through the target browser based on the page address of the target landing page, and trigger to write the multiple preloaded resources corresponding to the preload tag into the memory cache of the target browser based on the preload tag in the web page directory file for subsequent use.

In the above solution, since the memory cache is the fastest channel for acquiring the resource, reusing the memory cache of the browser may effectively improve the loading speed of the subsequent landing page.

Step 102: in response to a load trigger operation on the target landing page, reading the preloaded resource of the target landing page from the memory cache through the target browser, and loading the target landing page based on the preloaded resource of the target landing page.

The load trigger operation may be a trigger operation for loading and displaying the target landing page, which may specifically be a gesture control operation such as clicking, long pressing, double-clicking, etc., on the page entry of the target landing page in the information page, which is not limited in one or more embodiments of the present disclosure.

In at least an embodiment of the present disclosure, after receiving the load trigger operation of a user on the target landing page, the page loading apparatus may intercept a resource obtaining request when sending the resource obtaining request based on the page address of the target landing page and based on the generated target browser, and read the preloaded resource of the target landing page from the memory cache, that is, redirect to the page address of the target landing page using the same target browser, and a resource request may hit the memory cache of the target browser. Then, the target landing page is loaded based on the preloaded resource of the target landing page. In addition, if the preloaded resource of the target landing page does not exist in the memory cache of the target browser, the preloaded resource may be acquired from the local storage space. If the preloaded resource does not exist in the local storage space, the preloaded resource may be acquired from the target server of the target landing page. If there are other resources other than the preloaded resource on the target landing page, the other resources may be acquired from the target server of the target landing page, and the target landing page is loaded based on the preloaded resource and the other resources. The loading process may be to parse the resources and render the target landing page, and display the target landing page to the user.

The page loading method provided by one or more embodiments of the present disclosure includes: preloading a preloaded resource of a target landing page into a memory cache of a target browser in response to a launch of a target application, where the target landing page is a third-party landing page; and reading the preloaded resource of the target landing page from the memory cache through the target browser and loading the target landing page based on the preloaded resource of the target landing page in response to a load trigger operation on the target landing page. With the above technical solution, by preloading the preloaded resource of the third-party landing page into the memory cache of the browser when the application is launched, the preloaded resource may be directly read from the memory cache of the browser for fast loading when the third-party landing page is loaded, thereby greatly reducing the loading time of the third-party landing page without any adjustment to the third-party landing page, in turn increasing the display rate of the third-party landing page and giving users a better loading experience.

In some embodiments, there are a plurality of target landing pages, and the page loading method may further include: downloading preloaded resource packages of the target landing pages to a local storage space in sequence according to pre-download priorities of the multiple target landing pages from high to low, where the pre-download priorities are determined based on the number of accesses and/or preloading success rates.

The pre-download priority may be a priority for pre-downloading set for the target landing page. The higher the priority, the earlier the download. The pre-download priorities of different target landing pages may be determined based on the number of accesses and/or the preloading success rates. The number of accesses may be the historical access times of the target landing page, and the number of accesses is directly proportional to the pre-download priority. The higher the access number, the higher the pre-download priority. The preloading success rate may be the ratio of the number of successful loads of the target landing page by the preloading manner in the above embodiments to the total number of loads. The preloading success rate is directly proportional to the pre-download priority. The higher the preloading success rate, the higher the pre-download priority. When determining the preloading priority based on the number of accesses and the preloading success rate, weights of the access number and the preloading success rate may be set for weighted determination. The preloaded resource package may include a web page directory file of a target landing page and a file of a preloaded resource.

Specifically, before step 101, the page loading apparatus may sort the multiple target landing pages of the target application in the order of the pre-download priorities thereof from high to low, and download the preloaded resource packages of the target landing pages to the local storage space in sequence according to a sorting result for subsequent use.

In the above solution, when there are a large number of third-party landing pages, when preloading resource packages of the third-party landing pages are downloaded in advance, the preloading resource packages may be downloaded from high to low according to a preset pre-download priority, and the download order is optimized to ensure that third-party landing pages with a large amount of accesses and a high preloading success rate may be preferentially processed. Even when there are a large number of third-party landing pages and the preloading resource packages of all the third-party landing pages cannot be downloaded in time, it may be ensured that some third-party landing pages with a high priority are downloaded.

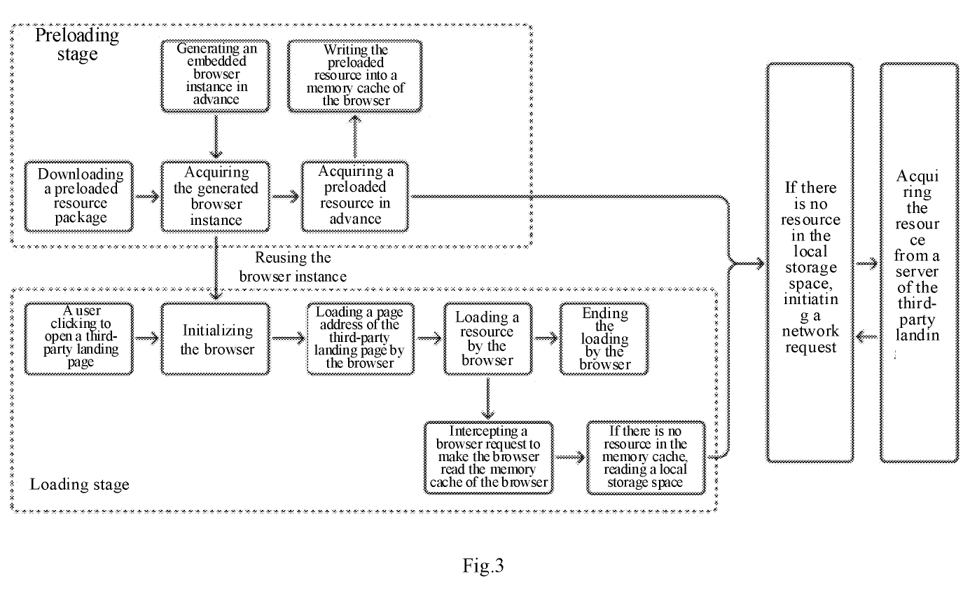

The page loading method provided by one or more embodiments of the present disclosure is further described below through a specific example. Exemplarily, FIG. 3 is a schematic diagram of a page loading process according to at least an embodiment of the present disclosure. As shown in FIG. 3, the page loading process may include a preloading stage and a loading stage, and the preloading stage may include: downloading a preloaded resource package and storing it in a local storage space; generating an embedded browser instance in advance and acquiring the generated browser instance; acquiring a preloaded resource in advance from the local storage space; writing the preloaded resource into a memory cache of the browser; and if there is no resource in the local storage space, initiating a network request to acquire the resource from a server of a third-party landing page. The loading stage may include: a user clicking to open the third-party landing page; initializing the browser and reusing the browser instance; loading a page address of the third-party landing page by the browser; loading the resource by the browser; intercepting a browser request to make the browser read the memory cache of the browser; if there is no resource in the memory cache, reading the local storage space; if there is no resource in the local storage space, initiating a network request to acquire the resource from the server of the third-party landing page; and ending the loading by the browser.

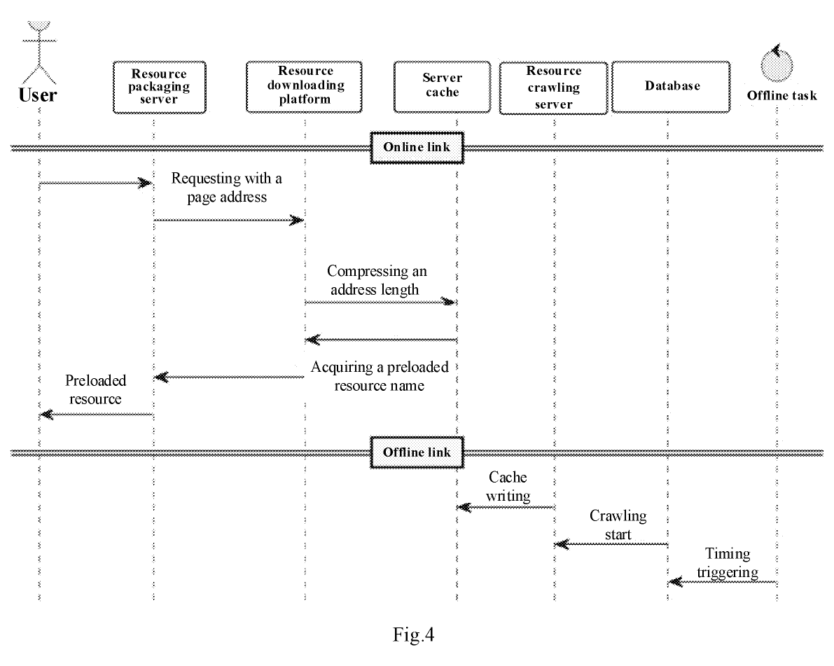

Exemplarily, FIG. 4 is a schematic diagram of another page loading process according to at least an embodiment of the present disclosure. As shown in FIG. 4, the figure shows the download process of the preloaded resource of the third-party landing page in the form of interaction at different ends, which may include an offline link and an online link in the figure. The offline link represents that the preloaded resource of the third-party landing page is stored into a server cache in advance, including timing triggering, crawling start, and cache writing. The timing triggering is performed through an offline task, and a resource crawling server crawls a preloaded resource package from a database of the server of the third-party landing page and writes it into the server cache. The online link represents that the preloaded resource is downloaded based on the page address of the third-party landing page when the target application is launched. The specific process includes: requesting, by a resource packaging server, a resource downloading platform with the page address of the third-party landing page; compressing, by the resource downloading platform, an address length to read the preloaded resource from the server cache; if the preloaded resource is hit, sending a preloaded resource name to the resource downloading platform; sending, by the resource downloading platform, the preloaded resource name to the resource packaging server; returning, by the resource packaging server, the preloaded resource to the target application; and then performing the loading stage in FIG. 3. The server of the target application in the figure may include the resource packaging server, the resource downloading platform, the server cache, and the resource crawling server in the figure, and the download of the preloaded resource of the third-party landing page is implemented through interaction.

Exemplarily, taking the third-party landing page being an advertisement landing page as an example, the resource crawling server selects an advertisement landing page with a highest preloading priority to enter a preloading candidate set through crawling and analysis of an overall advertisement link on the advertisement landing page. After an offline crawling server completes page analysis and preloaded resource package uploading, a resource address of the preloaded resource is stored into the server cache. In a delivery link, the resource downloading platform tries to read a preloaded resource package from the server cache and delivers the preloaded resource package if the preloaded resource package is hit. When there are a large number of advertisement landing pages, the resource crawling server often cannot analyze and crawl all the landing pages in time. Therefore, multi-round optimization is also performed on the crawling logic, and the crawling priority (that is, the preloading priority) is set or adjusted according to the access number, the preloading success rate, etc., to ensure that third-party landing pages with a large access number and a high preloading success rate may be preferentially downloaded.

Optionally, when downloading the preloaded resource package of the third-party landing page, the preloaded resource package may be first downloaded to a cloud storage platform, and subsequently, the preloaded resource may be downloaded from the cloud storage platform. For example, if the preloaded resource package of the third-party landing page is requested 10 times by 10 users, the preloaded resource package is downloaded from the server of the third-party landing page to the cloud storage platform only for once, and the remaining 9 times, the preloaded resource package is downloaded from the cloud storage platform. The above manner may reduce the access pressure on the server of the third-party landing page caused by pre-downloading the preloaded resource, and at the same time, improve the reading speed of the preloaded resource.

In the solution, resource loading optimization may be performed on the third-party landing page in advance without reconstructing the third-party landing page, which will not cause pressure on the server of the resources of the third-party landing page. The resources will hit the memory cache of the fastest browser as much as possible to shorten the page loading time and increase the page display rate, and the white screen display time of the first screen of the third-party landing page will be greatly reduced to reduce the loss rate of users on the third-party landing page, giving users a better loading experience, in turn improving the conversion rate of the page. For example, for an advertisement landing page, the page loading time may be greatly reduced, and the page loading success rate may be improved, indirectly increasing the user's willingness to actually perform conversion operations.

FIG. 5 is a schematic diagram of a structure of a page loading apparatus according to at least an embodiment of the present disclosure. The apparatus may be implemented by software and/or hardware, and may generally be integrated in an electronic device. As shown in FIG. 5, the apparatus includes:

a preloading module 501 configured to preload a preloaded resource of a target landing page into a memory cache of a target browser in response to a launch of a target application, where the target landing page is a third-party landing page; and

a loading module 502 configured to read the preloaded resource of the target landing page from the memory cache through the target browser in response to a load trigger operation on the target landing page, and load the target landing page based on the preloaded resource of the target landing page.

Optionally, the preloading module 501 includes:

a first unit configured to generate the target browser for the target landing page in the target application and acquire the preloaded resource of the target landing page; and

a second unit configured to write the preloaded resource of the target landing page into the memory cache of the target browser through the target browser.

Optionally, the first unit is configured to:

determine whether the preloaded resource of the target landing page exists in a local storage space; if yes, acquire the preloaded resource of the target landing page from the local storage space; otherwise, acquire the preloaded resource of the target landing page from a target server corresponding to the target landing page.

Optionally, the first unit is further configured to:

send a resource obtaining request to the target server corresponding to the target landing page based on a resource address of the preloaded resource to acquire the preloaded resource, where the resource address of the preloaded resource is obtained through domain name resolution in advance in response to display of an information page with a page entry of the target landing page.

Optionally, the second unit is configured to:

acquire a web page directory file of the target landing page through the target browser; and

trigger, based on a preload tag in the web page directory file, writing multiple preloaded resources corresponding to the preload tag into the memory cache of the target browser.

Optionally, the loading module 502 is configured to:

intercept a resource obtaining request when sending the resource obtaining request based on the page address of the target landing page and based on the generated target browser, and read the preloaded resource of the target landing page from the memory cache.

Optionally, the target landing page includes a plurality of target landing pages, and the apparatus further includes a downloading module configured to:

download preloaded resource packages of the target landing pages to a local storage space in sequence according to pre-download priorities of the plurality of target landing pages from high to low, where the pre-download priorities are determined based on the number of accesses and/or preloading success rates.

The page loading apparatus provided by one or more embodiments of the present disclosure may perform the page loading method provided by any embodiment of the present disclosure, and has corresponding functional modules and beneficial effects for performing the method.

At least an embodiment of the present disclosure further provides a computer program product, including a computer program/instruction. The page loading method provided by any embodiment of the present disclosure is implemented when the computer program/instruction is executed by a processor.

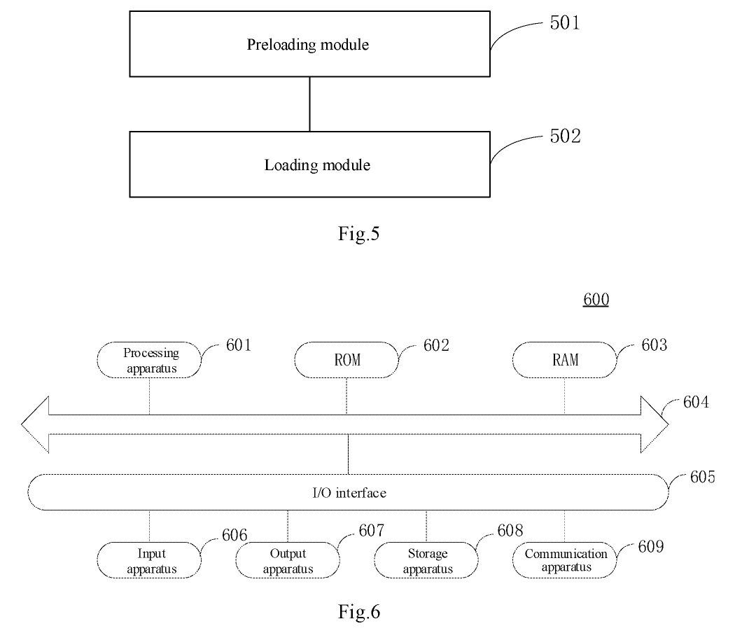

FIG. 6 is a schematic diagram of a structure of an electronic device according to at least an embodiment of the present disclosure. Reference is made specifically to FIG. 6 below, which illustrates a schematic diagram of a structure of an electronic device 600 suitable for implementing one or more embodiments of the present disclosure. The electronic device 600 in one or more embodiments of the present disclosure may include, but is not limited to, mobile terminals such as a mobile phone, a notebook computer, a digital broadcast receiver, a personal digital assistant (PDA), a tablet computer, a portable media player (PMP), an in-vehicle terminal (e.g., an in-vehicle navigation terminal), etc., and fixed terminals such as a digital TV, a desktop computer, etc. The electronic device shown in FIG. 6 is only an example, and should not impose any limitation on the function and scope of use of one or more embodiments of the present disclosure.

As shown in FIG. 6, the electronic device 600 may include a processing apparatus 601 (e.g., a central processing unit, a graphics processing unit, etc.), which may perform various suitable actions and processing according to a program stored in a read-only memory (ROM) 602 or a program loaded from a storage apparatus 608 into a random access memory (RAM) 603. The RAM 603 further stores various programs and data required for operations of the electronic device 600. The processing apparatus 601, the ROM 602, and the RAM 603 are connected to each other through a bus 604. An input/output (I/O) interface 605 is also connected to the bus 604.

Usually, the following apparatuses may be connected to the I/O interface 605: an input apparatus 606 including, for example, a touch screen, a touchpad, a keyboard, a mouse, a camera, a microphone, an accelerometer, a gyroscope, etc.; an output apparatus 607 including, for example, a liquid crystal display (LCD), a speaker, a vibrator, etc.; a storage apparatus 608 including, for example, a magnetic tape, a hard disk, etc.; and a communication apparatus 609. The communication apparatus 609 may allow the electronic device 600 to perform wireless or wired communication with other devices to exchange data. Although FIG. 6 shows the electronic device 600 with various apparatuses, it should be understood that it is not required to implement or have all the apparatuses shown. More or fewer apparatuses may be implemented or provided alternatively.

In particular, according to one or more embodiments of the present disclosure, the process described above with reference to the flowchart may be implemented as a computer software program. For example, one or more embodiments of the present disclosure include a computer program product, which includes a computer program carried on a non-transitory computer-readable medium, and the computer program includes program code for performing the method shown in the flowchart. In such an embodiment, the computer program may be downloaded and installed from a network through the communication apparatus 609, or installed from the storage apparatus 608, or installed from the ROM 602. When the computer program is executed by the processing apparatus 601, the above-mentioned functions defined in the page loading method of one or more embodiments of the present disclosure are executed.

It should be noted that the above-mentioned computer-readable medium in one or more embodiments of the present disclosure may be a computer-readable signal medium, a computer-readable storage medium, or any combination of the two. The computer-readable storage medium may be, for example, but is not limited to, an electrical, magnetic, optical, electromagnetic, infrared, or semiconductor system, apparatus, or device, or any combination of the above. More specific examples of the computer-readable storage medium may include, but are not limited to: an electrical connection having one or more wires, a portable computer magnetic disk, a hard disk, a random access memory, a read-only memory, an erasable programmable read-only memory (EPROM), an optical fiber, a portable compact disc read-only memory (CD-ROM), an optical storage device, a magnetic storage device, or any suitable combination of the above. In one or more embodiments of the present disclosure, the computer-readable storage medium may be any tangible medium that contains or stores a program, which may be used by or in combination with an instruction execution system, apparatus, or device. In one or more embodiments of the present disclosure, the computer-readable signal medium may include a data signal propagated in a baseband or as a part of a carrier wave, and computer-readable program code is carried in the data signal. This propagated data signal may take a variety of forms, including but not limited to an electromagnetic signal, an optical signal, or any suitable combination of the above. The computer-readable signal medium may also be any computer-readable medium other than the computer-readable storage medium, and the computer-readable signal medium may send, propagate, or transmit the program used by or in combination with the instruction execution system, apparatus, or device. The program code contained on the computer-readable medium may be transmitted in any suitable medium, including but not limited to: a wire, an optical cable, a radio frequency (RF), etc., or any suitable combination of the above.

In some implementations, the client and the server may communicate using any currently known or future developed network protocol, such as the HyperText Transfer Protocol (HTTP), and may be interconnected with any form or medium of digital data communication (for example, a communication network). Examples of the communication network include a local area network (LAN), a wide area network (WAN), an internet (for example, the Internet), a peer-to-peer network (for example, an Ad-Hoc network), and any network currently known or to be developed in the future.

The above-mentioned computer-readable medium may be included in the above-mentioned electronic device, or may exist alone without being assembled into the electronic device.

The above-mentioned computer-readable medium carries one or more programs, which, when executed by the electronic device, cause the electronic device to: preload a preloaded resource of a target landing page into a memory cache of a target browser in response to a launch of a target application, where the target landing page is a third-party landing page; and read the preloaded resource of the target landing page from the memory cache through the target browser in response to a load trigger operation on the target landing page, and load the target landing page based on the preloaded resource of the target landing page.

The computer program code for performing the operations of one or more embodiments of the present disclosure may be written in one or more programming languages or a combination thereof. The above-mentioned programming languages include object-oriented programming languages such as Java, Smalltalk, and C++, and may also include conventional procedural programming languages such as "C" language or similar programming languages. The program code may be executed entirely on a user's computer, partly executed on a user's computer, executed as an independent software package, partly executed on a user's computer and partly executed on a remote computer, or entirely executed on a remote computer or a server. In the case of involving a remote computer, the remote computer may be connected to a user's computer through any kind of network, including a local area network or a wide area network, or may be connected to an external computer (for example, connected by using Internet provided by an Internet service provider).

The flowcharts and block diagrams in the drawings illustrate the architecture, functionality, and operation of possible implementations of systems, methods and computer program products according to various embodiments of the present disclosure. In this regard, each block in the flowchart or block diagrams may represent a module, a program segment, or a portion of code that includes one or more executable instructions for implementing a specified logical function. Furthermore, it should be noted that, in some alternative implementations, functions indicated in the blocks may occur in an order different from that indicated in the drawings. For example, two blocks shown in succession may, in fact, be executed substantially concurrently, or the blocks may sometimes be executed in a reverse order, depending upon the functionality involved. It also should be noted that each block of the block diagrams and/or flowcharts, or a combination of blocks in the block diagrams and/or flowcharts may be implemented in a special purpose hardware-based system that perform a specified function or operation, or may be implemented in a combination of special purpose hardware and a computer instruction.

The units involved in the embodiments described in one or more embodiments of the present disclosure may be implemented by means of software, and may also be implemented by means of hardware. The name of a unit does not constitute a limitation on the unit itself under certain circumstances.

The functions described above herein may be performed at least in part by one or more hardware logic components. For example, without limitation, exemplary types of hardware logic components that may be used include: a field-programmable gate array (FPGA), an application specific integrated circuit (ASIC), an application specific standard parts (ASSP), a system on chip (SOC), a complex programmable logic device (CPLD), etc.

In the context of the present disclosure, a machine-readable medium may be a tangible medium that may contain or store a program for use by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the above. More specific examples of the machine-readable storage medium would include an electrical connection based on one or more wires, a portable computer diskette, a hard disk, a random access memory, a read-only memory, an erasable programmable read-only memory, a flash memory, an optical fiber, a portable compact disc read-only memory, an optical storage device, a magnetic storage device, or any suitable combination of the above.

It may be understood that before the use of the technical solutions disclosed in one or more embodiments of the present disclosure, the user should be informed of the type, range of use, use scenarios, etc., of information involved in one or more embodiments of the present disclosure in an appropriate manner and the authorization of the user should be obtained in accordance with relevant laws and regulations.

The above description is only some embodiments of the present disclosure and an explanation of the technical principles employed. Those skilled in the art should understand that the scope of disclosure involved in the present disclosure is not limited to the technical solutions formed by the specific combination of the above-mentioned technical features, and should also cover, without departing from the above-mentioned disclosed concept, other technical solutions formed by any combination of the above-mentioned technical features or their equivalents, such as technical solutions which are formed by replacing the above-mentioned technical features with the technical features disclosed in the present disclosure (but not limited to) with similar functions.

Additionally, although operations are depicted in a particular order, it should not be understood that these operations are required to be performed in a specific order as illustrated or in a sequential order. Under certain circumstances, multitasking and parallel processing may be advantageous. Likewise, although the above discussion includes several specific implementation details, these should not be interpreted as limitations on the scope of the present disclosure. Certain features that are described in the context of separate embodiments may also be implemented in combination in a single embodiment. Conversely, various features that are described in the context of a single embodiment may also be implemented in multiple embodiments separately or in any suitable sub-combination.

Although the subject matter has been described in language specific to structural features and/or logical actions of the method, it should be understood that the subject matter defined in the appended claims is not necessarily limited to the specific features or actions described above. Rather, the specific features and actions described above are merely example forms of implementing the claims.

1. A page loading method, comprising:
preloading a preloaded resource of a first landing page into a memory cache of a first browser in response to a launch of a first application, wherein the first landing page is a third-party landing page; and
in response to a load trigger operation on the first landing page, reading the preloaded resource of the first landing page from the memory cache through the first browser, and loading the first landing page based on the preloaded resource of the first landing page.

2. The method of claim 1, wherein the preloading a preloaded resource of a first landing page into a memory cache of a first browser comprises:
generating the first browser for the first landing page in the first application and acquiring the preloaded resource of the first landing page; and
writing the preloaded resource of the first landing page into the memory cache of the first browser through the first browser.

3. The method of claim 2, wherein the acquiring the preloaded resource of the first landing page comprises:
determining whether the preloaded resource of the first landing page exists in a local storage space;
in response to that the preloaded resource of the first landing page exists in a local storage space, acquiring the preloaded resource of the first landing page from the local storage space; and
in response to that the preloaded resource of the first landing page does not exist in a local storage space, acquiring the preloaded resource of the first landing page from a first server corresponding to the first landing page.

4. The method of claim 3, wherein the acquiring the preloaded resource of the first landing page from a first server corresponding to the first landing page comprises:
sending a resource obtaining request to the first server corresponding to the first landing page based on a resource address of the preloaded resource to acquire the preloaded resource, wherein the resource address of the preloaded resource is obtained through domain name resolution in advance in response to display of an information page with a page entry of the first landing page.

5. The method of claim 2, wherein the writing the preloaded resource of the first landing page into the memory cache of the first browser through the first browser comprises:
acquiring a web page directory file of the first landing page through the first browser; and
triggering, based on a preload tag in the web page directory file, writing of multiple preloaded resources corresponding to the preload tag into the memory cache of the first browser.

6. The method of claim 1, wherein the reading the preloaded resource of the first landing page from the memory cache through the first browser comprises:
intercepting a resource obtaining request when sending the resource obtaining request based on a page address of the first landing page and based on the first browser generated, and reading the preloaded resource of the first landing page from the memory cache.

7. The method of claim 1, wherein the first landing page comprises a plurality of first landing pages, and the method further comprises:
downloading a preloaded resource package for each of the plurality of first landing pages to a local storage space in sequence according to pre-download priorities of the plurality of first landing pages from high to low, wherein the pre-download priorities are determined based on a number of accesses and/or preloading success rates.

8. An electronic device, comprising:
at least one processor; and
a memory, configured to store computer instructions executable by the at least one processor,
wherein the computer instructions, when executed by the at least one processor, causes the at least one processor to perform a page loading method, which comprise:
preloading a preloaded resource of a first landing page into a memory cache of a first browser in response to a launch of a first application, wherein the first landing page is a third-party landing page; and
in response to a load trigger operation on the first landing page, reading the preloaded resource of the first landing page from the memory cache through the first browser, and loading the first landing page based on the preloaded resource of the first landing page.

9. The electronic device of claim 8, wherein the preloading a preloaded resource of a first landing page into a memory cache of a first browser comprises:
generating the first browser for the first landing page in the first application and acquiring the preloaded resource of the first landing page; and
writing the preloaded resource of the first landing page into the memory cache of the first browser through the first browser.

10. The electronic device of claim 9, wherein the acquiring the preloaded resource of the first landing page comprises:
determining whether the preloaded resource of the first landing page exists in a local storage space;
in response to that the preloaded resource of the first landing page exists in a local storage space, acquiring the preloaded resource of the first landing page from the local storage space; and
in response to that the preloaded resource of the first landing page does not exist in a local storage space, acquiring the preloaded resource of the first landing page from a first server corresponding to the first landing page.

11. The electronic device of claim 10, wherein the acquiring the preloaded resource of the first landing page from a first server corresponding to the first landing page comprises:
sending a resource obtaining request to the first server corresponding to the first landing page based on a resource address of the preloaded resource to acquire the preloaded resource, wherein the resource address of the preloaded resource is obtained through domain name resolution in advance in response to display of an information page with a page entry of the first landing page.

12. The electronic device of claim 9, wherein the writing the preloaded resource of the first landing page into the memory cache of the first browser through the first browser comprises:
acquiring a web page directory file of the first landing page through the first browser; and
triggering, based on a preload tag in the web page directory file, writing of multiple preloaded resources corresponding to the preload tag into the memory cache of the first browser.

13. The electronic device of claim 8, wherein the reading the preloaded resource of the first landing page from the memory cache through the first browser comprises:
intercepting a resource obtaining request when sending the resource obtaining request based on a page address of the first landing page and based on the first browser generated, and reading the preloaded resource of the first landing page from the memory cache.

14. The electronic device of claim 8, wherein the first landing page comprises a plurality of first landing pages, and the at least one processor is caused to further perform:
downloading a preloaded resource package for each of the plurality of first landing pages to a local storage space in sequence according to pre-download priorities of the plurality of first landing pages from high to low, wherein the pre-download priorities are determined based on a number of accesses and/or preloading success rates.

15. A non-transitory computer-readable storage medium, wherein the storage medium is stored with computer instructions, and the computer instructions, when executed by at least a processor, cause the processor to perform a page loading method, which comprises:
preloading a preloaded resource of a first landing page into a memory cache of a first browser in response to a launch of a first application, wherein the first landing page is a third-party landing page; and
in response to a load trigger operation on the first landing page, reading the preloaded resource of the first landing page from the memory cache through the first browser, and loading the first landing page based on the preloaded resource of the first landing page.

16. The storage medium of claim 15, wherein the preloading a preloaded resource of a first landing page into a memory cache of a first browser comprises:
generating the first browser for the first landing page in the first application and acquiring the preloaded resource of the first landing page; and
writing the preloaded resource of the first landing page into the memory cache of the first browser through the first browser.

17. The storage medium of claim 16, wherein the acquiring the preloaded resource of the first landing page comprises:
determining whether the preloaded resource of the first landing page exists in a local storage space;
in response to that the preloaded resource of the first landing page exists in a local storage space, acquiring the preloaded resource of the first landing page from the local storage space; and
in response to that the preloaded resource of the first landing page does not exist in a local storage space, acquiring the preloaded resource of the first landing page from a first server corresponding to the first landing page.

18. The storage medium of claim 17, wherein the acquiring the preloaded resource of the first landing page from a first server corresponding to the first landing page comprises:
sending a resource obtaining request to the first server corresponding to the first landing page based on a resource address of the preloaded resource to acquire the preloaded resource, wherein the resource address of the preloaded resource is obtained through domain name resolution in advance in response to display of an information page with a page entry of the first landing page.

19. The storage medium of claim 16, wherein the writing the preloaded resource of the first landing page into the memory cache of the first browser through the first browser comprises:
acquiring a web page directory file of the first landing page through the first browser; and
triggering, based on a preload tag in the web page directory file, writing of multiple preloaded resources corresponding to the preload tag into the memory cache of the first browser.

20. The storage medium of claim 15, wherein the reading the preloaded resource of the first landing page from the memory cache through the first browser comprises:
intercepting a resource obtaining request when sending the resource obtaining request based on a page address of the first landing page and based on the first browser generated, and reading the preloaded resource of the first landing page from the memory cache.
